(19) United States
(12) Patent Application Publication
(10) Pub. No.: US 2007/0172339 A1
(43) Pub. Date: Jul. 26, 2007

(54) Apparatus and methods to transfer materials from storage containers

(76) Inventors: Mark La Forest, Granger, IN (US); Michael Worrell, Elkton, MD (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/340,874

(22) Filed: Jan. 26, 2006

(51) Int. Cl. B65F 3/02

(52) U.S. Cl. 414/404

(57) ABSTRACT

An apparatus and methods for transferring powder material from a storage drum to a processing container is disclosed. The apparatus has a dumper which receives a container of powder. The dumper moves the storage container between a loading position and an unloading position where the container is at least partially inverted. An enclosure with an access opening to receive the powder from the storage container when the container is in the unloading position is provided

### TECHNICAL FIELD

The present disclosure pertains to material handling, and more particularly, to an apparatus and methods to transfer powder in the form of microspheres from a large storage container to a smaller container.

### BACKGROUND

Phenolic powder, may be received as a fragile, low bulk density hollow powder which is composed of microspheres in a thermoplastic resin form. It is desirable to carbonize the microspheres by placing the powder into graphite containers and then treating the containers and material by extreme heating. The microspheres which are 15-150 microns in diameter before and after the heat treatment process. The carbonized microspheres have a variety of uses. For example, they may be used as the basis of a low density insulating material. The hollow phenolic powder is not considered a free flowing material because of its low-bulk density and if aerated or fluidized, the hollow pehnolic powder may exhibit packing or caking.

Handling this phenolic powder is dangerous because its composition is a high density exothermic material which is easily combustible. In fact, the material may spontaneously smolder at relatively low temperatures. Typically, such materials are transported in standard 55 gallon drums. Presently, such materials are manually loaded from the drum into a smaller graphite container for use in the heat treatment step in order to process the material as explained above. The powder must be protected in order to prevent caking or packing which could damage the utility of the microspheres. The transfer of such powder from a 55 gallon drum is dangerous because microsphere dust is created in the transfer process. Such dust is combustible and creates a hazard for employees responsible for the transfer of the powder from the drum to process machinery. Moreover, powder dust generated from the transfer is essentially wasted material. Since the powder is expensive, such waste is undesirable.

Moreover, the powder is fragile and must be protected during the transfer process. Since the powder is susceptible to clotting, the flow of the powder from the drum to the process machinery may cause clogging of the conduits, making it difficult to transfer the powder to the processing machinery.

### BRIEF DESCRIPTION OF THE DRAWINGS

FIG. 1 is a perspective view of an example apparatus to transfer phenolic powder shown with the drum in a lowered position.

FIG. 2 is a side view of the example transfer apparatus of FIG. 1 shown with the drum in the raised loading position.

FIG. 3 is a side view of the example transfer apparatus of FIG. 1 shown with the rotating arm in an unloading position and the drum placed in a raised, inverted position.

FIG. 4 is a view of the example transfer apparatus from the drum loading door with the drum in the lowered position.

FIG. 5 is a view of the dust hood work station and piping to the dust collector of the example transfer apparatus in FIG. 1.

### DETAILED DESCRIPTION

While the present invention is capable of embodiment in various forms, there is shown in the drawings and will hereinafter be described a presently preferred embodiment with the understanding that the present disclosure is to be considered as an exemplification of the invention, and is not intended to limit the invention to the specific embodiment illustrated.

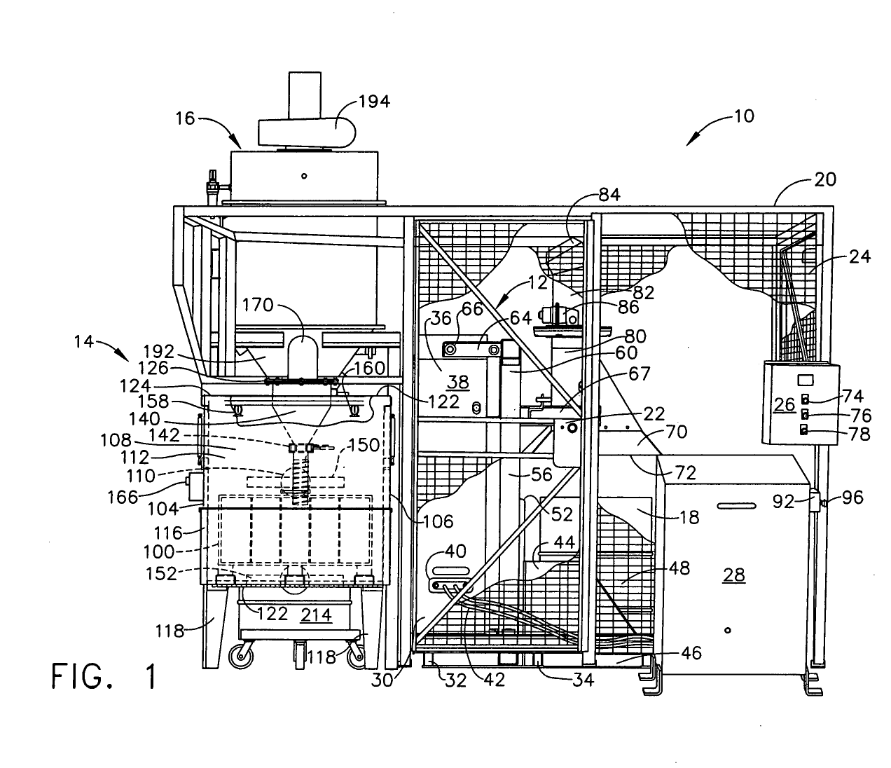

An example transfer apparatus 10 is illustrated in FIGS. 1-5. The illustrated transfer apparatus 10 includes a drum dumper 12, a work station 14 and a dust collector 16. The example apparatus 10 of FIG. 1 allows the transfer of phenolic powder in the form of hollow microspheres from a storage container which may be a typical 55 gallon steel drum such as drum 18 which is held by the drum dumper 12 to the work station 14. Of course, persons of ordinary skill in the art will appreciate that other types of storage containers may be used with the apparatus 10. The drum dumper 12 and the work station 14 are surrounded by a safety enclosure 20 which includes an access door 22 and a drum door 24 to protect users from the moving parts of the drum dumper 12 as explained below. The enclosure 20 includes a control box 26 and a controller hood 28. Persons of ordinary skill in the art will appreciate that the apparatus 10 may be used to transfer other types of materials such as any free flowing hazardous or non-hazardous powders or granules.

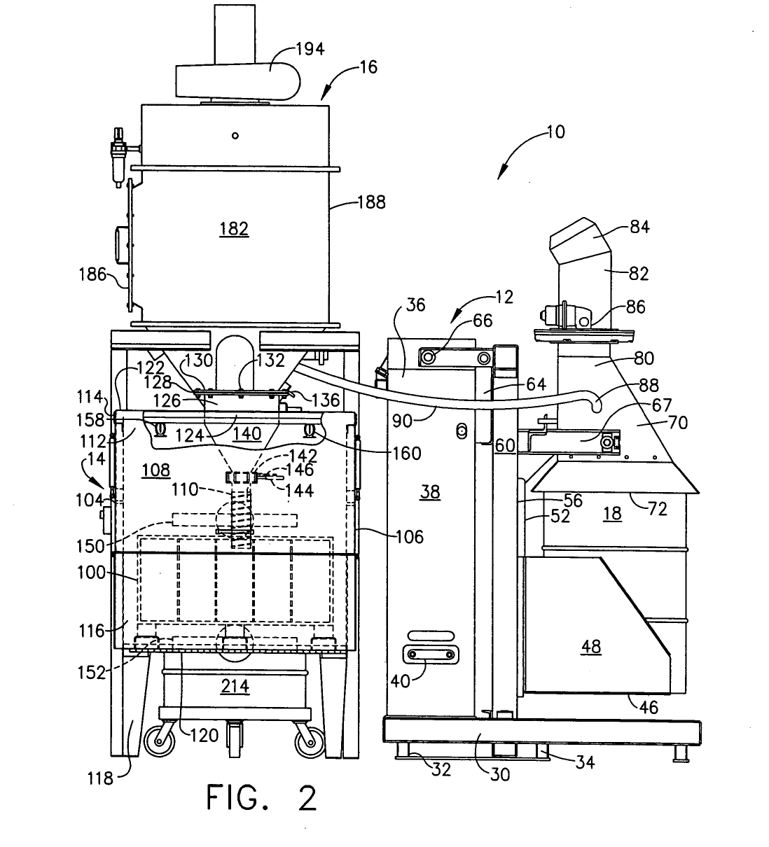

The drum dumper 12 has a base 30 which is mounted on a pair of skids 32 and 34. The base 30 mounts a support housing 36 which encloses the electrical and hydraulic machinery (not shown) for the components described below. The support housing 36 has a side wall 38 with an access port 40 with various hydraulic supply lines 42. The base 30 also has a lift 44 on which the drum 18 is held. The lift 44 has a loading pad 46 which accommodates the bottom of the drum 18. The lift 44 has a pair of side walls 48 and 50 which extend vertically and serve to constrain the movement of the drum 18 on the pad 46. The lift 44 has a pair of track members 52 and 54 which traverse a pair of guides 56 and 58 mounted respectively on a pair of support arms 60 and 62 to move the drum 18 vertically from a lower position for initial placement of the drum 18 to a higher, raised position as shown in FIG. 2 for the unloading operation. The lift 44 is powered by hydraulic pressure, but persons of ordinary skill in the art will appreciate that other mechanisms such as electrical motors or pneumatic pressure may be used to operate the lift 44.

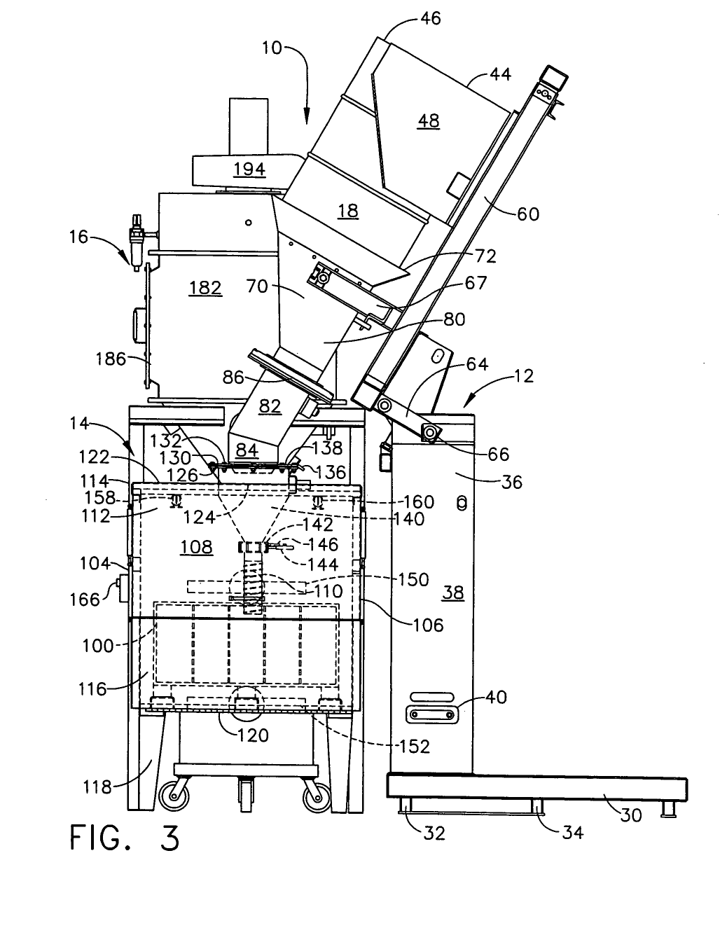

The drum dumper 12 also has a rotating arm 64 which rotates around a pivot 66 installed on the support housing 36. The rotating arm 64 is connected to the support arms 60 and 62 and thus rotates the drum 18 from a loading position shown in FIG. 2 to an inverted unloading position shown in FIG. 3. In this example, the rotating arm 64 is rotated by an electrical motor (not shown), although persons of ordinary skill in the art will appreciate that other equivalent actuators such as hydraulics or pneumatic pistons may be used.

In the illustrated example, each of the support arms 60 and 62 have a horizontal member 67 and 68 respectively which supports a funnel 70. The funnel 70 has an open end 72 which will accommodate the top of the drum 18 when the drum 18 is raised on the lift 44 as shown in FIG. 2.

The control box 26 of this illustrated example has a start button 74, a stop button 76 and a dust collector button 78. Activation of the start button 74 allows power to be supplied to all components. Activation of the stop button 76 cuts off power to all components. As will be explained below, changing the state of the dust collector button 78 starts and stops the dust collector 16.

The funnel 70 of the illustrated example has a semi-conical shape with the relatively wide open end 72 and an opposite narrow end 80. The narrow end 80 is connected to a conduit 82. As shown in FIG. 3, when the support arms 60 and 62 are rotated around the pivot 66, the drum 18 is inverted and the funnel 70 directs materials from the drum 18 through the open end 72 to the narrow end 80 of the funnel 70, and then through the conduit 82 to an angled nozzle 84. The conduit 82 of the illustrated example has a pneumatic iris valve 86 near the narrow end 80 of the funnel 70 allowing control of the flow of materials from the drum 18 to the funnel 70. Of course, those of ordinary skill in the art will appreciate that other types of valves may be used for the iris valve 86. The funnel 70 has an air vent port 88 which is connected to a suction hose 90. The suction hose 90 allows for the removal of dust generated from the removal of an empty or partially emptied drum such as drum 18 from under the funnel 70 to the dust collector 16.

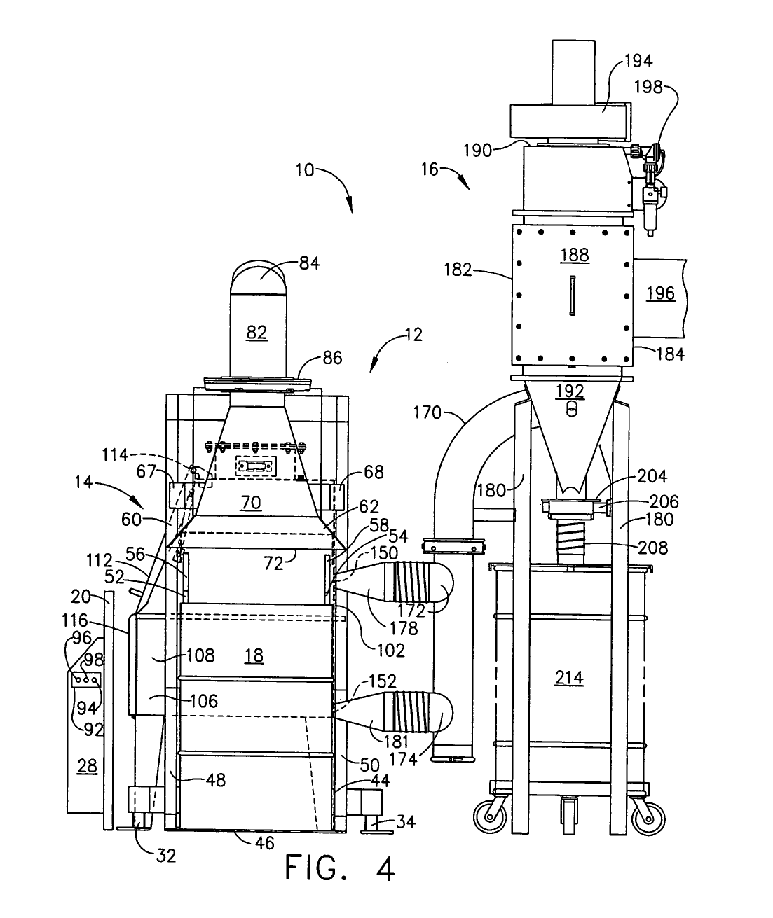

As shown in FIG. 4, the drum dumper 12 of the illustrated example has an upright position. After the drum 18 is loaded on the lift 44 via the drum door 24, the drum dumper 12 can be moved into the raised position to fit the top of the drum 18 into the open end 72 of the funnel 70. A control panel 92 is mounted on the controller hood 28 in the illustrated example. The control panel 92 has an override button 94. It has additional controls for activating the rotation of the pad 46 between the loading and unloading positions. The controls include a load switch 96 and an unload switch 98. Those of ordinary skill the art will appreciate that other controls such as, for example, foot pedals may be used to operate the rotation of the arms 60 and 62 and the attached pad 46.

After the drum 18 is loaded on the pad 46 with the pad 46 in a lowered position (see, e.g. FIG. 1), the lift 44 is raised to a raised position such as the position shown in FIG. 2 so the top of the drum 18 is inserted into the open end 72 of the funnel 70. By activating the unload switch 96, the drum dumper 12 may be placed in an unloading and inverted position such as the position shown in FIG. 3 in which the support arms 60 and 62 and lift 44 are rotated until the drum 18 is inverted at an angle from the vertical plane sufficient to allow gravity to pull the materials out of the drum 18. The contents of the drum 18 then flow out of the drum 18 via gravity through the open end 72 of the funnel 70 to the narrow end 80 out of the nozzle 84. After the drum 18 is emptied, the drum dumper 12 may be returned to a loading position by activating the load switch 98. The operation of the drum dumper 12 may be stopped at any point by activating the override button 94.

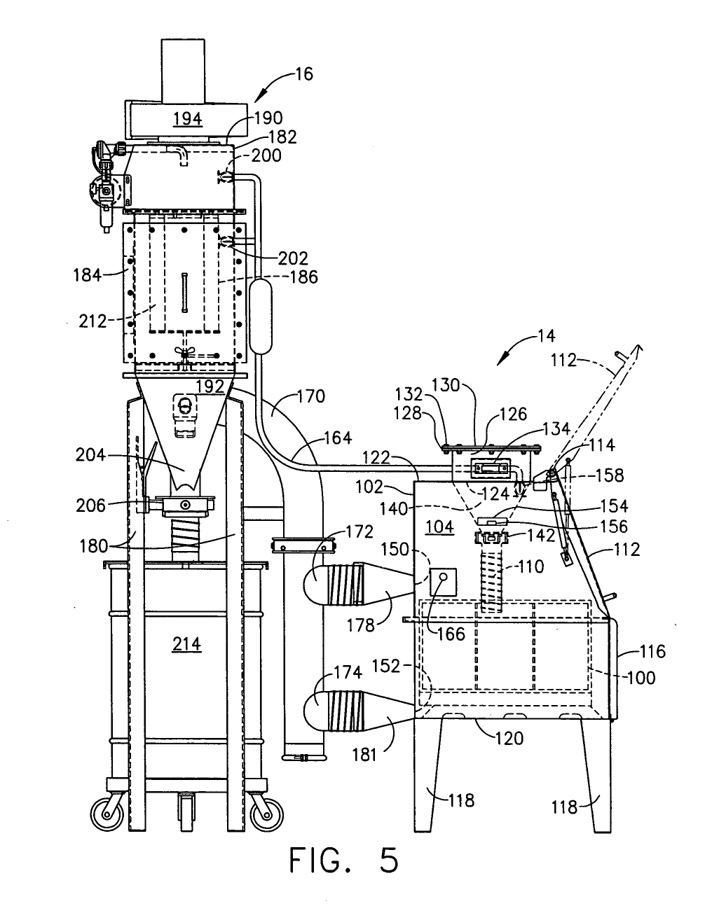

As shown in greater detail in FIGS. 3 and 5, the work station 14 of the illustrated example allows a user to control the flow of the powder from the drum 18 to fill one or more processing containers such as a series of storage bins 100. The storage bins 100 in this example are constructed of graphite for use in heat processing of the powder. As will be appreciated by those of ordinary skill in the art, other types of containers may be used to hold the transferred powder.

The work station 14 of the illustrated example has a back wall 102 and a pair of side walls 104 and 106 which form a dust hood enclosure 108. The dust hood enclosure 108 contains a hose 110 for transfer of the powder to the bins 100. The dust hood enclosure 108 traps dust produced by the transfer of the powder to the bins 100. Access to the dust hood enclosure 108 is made via an access door 112 which is attached to the enclosure 108 by a hinge 114. A front wall 116 forms the remainder of the enclosure and shields the bins 100. The work station 14 of the illustrated example is supported by four legs 118.

The work station 14 of the illustrated example also has a bottom panel 120 and a top panel 122. The top panel 122 has an access opening 124 which is framed by a conduit 126 having an annular mounting surface 128. The access opening 124 is of sufficient diameter to accommodate the nozzle 84 of the drum dumper 12. A locking collar 130 is mounted via a series of bolts 132 to the annular mounting surface 128. The locking collar 130 is coupled to a turbine vibrator 134 which allows the collar 130 to be agitated in an oscillating motion in the access opening 124. The locking collar 130 and annular mounting surface 128 sandwich a flexible layer 136 which contains an access opening 138. The flexible layer 136 surrounds the nozzle 84 when the drum 18 is inverted as shown in FIG. 3 to substantially prevent dust from escaping when the nozzle 84 is inserted into the access opening 124. The vibrator 134 serves to shake loose any powder which may be clumped in the nozzle 84. The turbine vibrator is air actuated but other types of vibration devices may be used.

The access opening 124 forms the wide end of an inverted conical conduit 140. The opposite narrow end of the conical conduit 140 is attached to the flexible hose 110. The flexible hose 110 carries the materials from the nozzle 84 to the bins 100 located on the bottom panel 120 of the work station 14.

In the illustrated example, a pinch valve 142 is coupled to the end of the flexible hose 110. The pinch valve 142 has two handles 144 and 146 which allow a user to close the valve 142 and, thus, prevent the flow of material from the inverted conical conduit 140 into the flexible hose 110. When the storage drum 18 is inverted in the unloading position (e.g. the position shown in FIG. 3), the access opening 124 receives the material from the storage drum 18 and the material passes to the conical conduit 140.

As exampled above, the series of empty storage bins 100 are placed on the bottom panel 120 of the work station 14. A user may open the access door 112 as shown in FIG. 5 in order to take the flexible hose 110 and move it over the storage bins 100 to fill each individual bin. Once the desired bin or bins 100 have been filled, the pinch valve 142 and/or the iris valve 86 may be shut to cut off the flow of additional powder. The bins 100 may then be removed from the enclosure 108 for further processing. Alternatively, a second door may be located in place of the front wall 116 to allow the bin(s) 100 to be loaded or unloaded into the enclosure 108 via a fork lift or other mechanical device.

The dust hood enclosure 108 of the illustrated example traps the dust produced by the transfer operation. Those of ordinary skill the art will appreciate that the illustrated apparatus can be modified in other ways to fill the bins 100. For example, work gloves installed in the walls of the dust hood enclosure 108 could be used to manipulate the hose 110 without opening the access door 112 to ensure a substantially or even totally contained transfer. Alternatively, remote automatic control of the hose 110 using, for example, servo motors coupled to the hose 110 could be used to isolate the transfer of the powder to the bin(s) 100.

As shown in FIGS. 4 & 5, the back wall 102 of the work station 14 of the illustrated example has upper and lower ventilation slits 150 and 152 which are used to ventilate the dust hood enclosure 108 in order to remove stray dust generated by the transfer process. In addition, the side wall 104 of the illustrated example has a light slit 154 which has a light 156 used to illuminate the dust hood enclosure 108. The dust hood enclosure 108 has a fire suppression system such as, for example, a pair of sprinkler heads 158 and 160 which are installed on the interior of the top panel 122. The sprinkler heads 158 and 160 are attached to a fire suppression material supply 162 (shown in FIG. 5) via a piping network 164. The sprinkler heads 158 and 160 can flood the dust hood enclosure 108 with the fire suppression material (e.g. water or foam) in order to prevent combustion of the powder or dust. The triggering of the sprinkler heads 158 and 160 may be automatically initiated by a temperature sensor or may be manually triggered by the user. As shown in FIG. 5, the light 156 may be turned on and/or off via an external switch 166.

In the illustrated example, the dust collected from the funnel 70 in the drum dumper 12 and the dust hood enclosure 108 of the work station 14 is contained in a dust collector 16 which is shown in FIGS. 2, 4 and 5. A vertical suction pipe 170 has an upper branch 172 and a lower branch 174. The upper branch 172 is connected via an adaptor 178 to the upper ventilation slit 150 of the back wall 102 and the lower branch 174 is connected via an adaptor 181 to the lower ventilation slit 152 of the back wall 102.

The dust collector 16 of the illustrated example is mounted on four support legs 180. The dust collector 16 has a chamber defined by a front wall 182, a back wall 184, and two side walls 186 and 188. The dust collector 16 also has a top panel 190 and a conically shaped bottom 192. A blower 194 is mounted on the top panel 190 to create suction force in the chamber to attract dust away from the work station 14 and the funnel 70. The vertical suction pipe 170 and the suction hose 90 from the funnel 70 are connected to the conical bottom 192 of the dust collector 16. An exhaust vent 196 extends from the side wall 186 and an air intake 198 extends from the side wall 186. The air intake 198 provides the blower 194 with a fresh supply of air which is circulated via the exhaust vent 196. The exhaust vent 196 also serves the purpose as an explosion vent from the chamber of the dust collector 16.

In the illustrated example, a pair of sprinkler nozzles 200 and 202 are mounted on the front wall 182 of the dust collector 16 for fire suppression. The sprinkler nozzles 200 and 202 are connected to the piping network 164. The conical bottom 192 has a collection portal 204 and a pinch valve 206. As shown in FIG. 4, a hose 208 is coupled to the pinch valve 206. A filter bag 212 lines the chamber of the dust collector 16 which traps the dust from the exhaust vent 196 and the air intake 198. The blower 194 is activated by pushing the dust collector button 78 on the control box 26 in FIG. 1. The blower 194 creates a suction force in the chamber of the dust collector 16 which sucks dust out of the hood enclosure 108 and the funnel 70. The dust collected in the chamber of the dust collector 16 is trapped in the filter bag 212 and is removed via opening the pinch valve 206 and causing the dust to be sucked out of the hose 208. The dust thus may be collected and reused by placing a dust container such as a storage drum 214 under conical bottom 192 to be filled with the hose 208. Alternatively, the dust may be simply removed to a disposal container such as the storage drum 214.

Although certain methods and apparatus have been described herein, the scope of coverage of this patent is not limited thereto. On the contrary, this patent covers all apparatus, methods and articles of manufacture fairly falling within the scope of the appended claims either literally or under the doctrine of equivalents.

What is claimed is:

1. An apparatus to transfer powder from a storage container, the apparatus comprising:
a dumper which receives a container of powder, the dumper to move the storage container between a loading position and an unloading position wherein the container is at least partially inverted; and
an enclosure with an access opening to receive the powder from the storage container when the container is in the unloading position.

2. The apparatus as defined in claim 1, further comprising a dust collector, the dust collector includes:
a chamber having an air intake conduit and an exhaust vent;
a blower in communication with the chamber to create suction force; and
a suction pipe coupled to the enclosure.

3. The apparatus as defined in claim 2, wherein the dust collector further includes a filter and wherein the chamber is in communication with a collection container.

4. The apparatus as defined in claim 2 wherein the enclosure includes a ventilation opening in communication with the suction pipe.

5. The apparatus as defined in claim 2 wherein the dumper includes a rotating arm having a loading pad and a funnel having an open end, the loading pad being dimensioned to receive the storage container, the open end of the funnel at least partially accommodating the storage container.

6. The apparatus as defined in claim 5 wherein the loading pad is raised from a lower position to a raised position to at least partially insert the storage container into the open end of the funnel.

7. The apparatus as defined in claim 5 wherein the funnel has a narrow end in communication to a nozzle, the nozzle being inserted in the access opening of the enclosure.

8. The apparatus as defined in claim 7 wherein the funnel has a valve to control the material flowing through the funnel.

9. The apparatus as defined in claim 7 wherein the access opening has a collar coupled to a vibrator.

10. The apparatus as defined in claim 5 wherein the nozzle is positioned at an angle to the funnel and wherein the container is inverted at the angle to a vertical plane when the container is in the unloading position.

11. The apparatus as defined in claim 5 further comprising a first control to activate the arm to rotate to the loading position and a second control to activate the arm to rotate to the unloading position.

12. The apparatus as defined in claim 1 wherein the access opening is in communication with a wide end of a conical conduit, the conduit having a pinch valve to control the flow of material, and a narrow end coupled to a hose.

13. The apparatus as defined in claim 1 wherein the enclosure has an access door.

14. The apparatus as defined in claim 10 wherein the enclosure has attached gloves to allow manipulation of the hose.

15. The apparatus of claim 1 further comprising a fire suppression system in the enclosure.

16. The apparatus as defined in claim 1 wherein the enclosure has processing containers to receive powder from the storage container.

17. The apparatus as defined in claim 15 wherein the powder is phenolic hollow powder in the form of microspheres.

18. A method to transfer powder from a storage container, the method comprising:
placing a storage container of powder on a dumper;
moving the storage container from a loading position to an unloading position wherein the storage container is at least partly inverted; and
allowing the powder to flow out of the storage container into an enclosure via an access opening.

19. The method as defined in claim 17 further comprising collecting dust from the enclosure.

20. The method as defined in claim 17 wherein the allowing powder to flow further comprises vibrating a connector between the container and the enclosure to shake loose any trapped powder.

21. The method as defined in claim 17 further comprising filling a graphite processing container in the enclosure with the powder.

22. The method as defined in claim 20 wherein the powder is phenolic hollow powder in the form of microspheres.

23. An apparatus to transfer powder from a storage container, the apparatus comprising:
a first container to receive powder;
an enclosure containing the first container;
a second container holding powder having a larger volume then the first container;
a hose to drain powder from the second container to the first container;
a dumper including a rotating arm to hold the second container, a funnel coupled to the rotating arm, the funnel having an open end to insert the second container; and
wherein the rotating arm moves the storage container between a loading position and an unloading position wherein the second container is at least partially inverted to allow powder to flow through the funnel to the hose of the enclosure.
